(19) United States
(12) Patent Application Publication
(10) Pub. No.: US 2006/0154598 A1
(43) Pub. Date: Jul. 13, 2006

(54) Configuring a radio network for selective broadcast

(76) Inventors: Philip A. Rudland, Horley (GB); David M. Avery, Woking (GB); Philip A. Jamieson, Dorking (GB)

Correspondence Address: PHILIPS INTELLECTUAL PROPERTY & STANDARDS, P.O. BOX 3001, BRIARCLIFF MANOR, NY, 10510, US

(21) Appl. No.: 10/559,217

(22) PCT Filed: Jun. 4, 2004
(86) PCT No.: PCT/IB04/01906

§ 371 Date: Dec. 6, 2005

(30) Foreign Application Priority Data
Jun. 11, 2003 (GB) 0313473.1

(51) Int. Cl. H04H 1/00

(52) U.S. Cl. 455/3.01

(57) ABSTRACT

A method for configuring and operating a radio system employing the ZigBee radio standard is described. The method advantageously enables a group of radio devices which are logically linked to another radio device to respond with low latency to a message. The method comprises a group identifier being generated and issued to logically linked devices, details of which are provided in a pre-installed binding table. In operation, a radio message from a device which is logically linked to another is received by a device coordinator which then broadcasts (100) the message with the generated group identifier. Only those devices which have previously received a matching group identifier (140) respond (150) to the broadcast message. Since broadcasts are not acknowledged, a rapid system response is achieved. This is important in lighting applications where a user expects instantaneous operation of lamps at the flick of a logically linked radio light switch.

The present invention relates to a method for configuring a radio network such that devices within the network are able to selectively respond to broadcast messages. The present invention has particular, but not exclusive, application to radio frequency devices using the ZigBee radio standard. Furthermore, the devices may be employed in a lighting system where timely responses to messages are required.

The IEEE™ and the ZigBee Alliance group of companies are, at the time of writing, standardising a low power, low cost digital radio standard known as ZigBee™ (IEEE802.15.4) operating at 868 MHz, 915 MHz or 2.4 GHz in the ISM frequency bands. The standard makers (www.ZigBee.com) envisage a wide area of application for ZigBee, from test and control to instrumentation and lighting. In general, master-slave or star configurations are employed to form a piconet, and several piconets may co-exist with routing of messages from a source device to a destination device being handled by a network layer in the radio stack of master devices.

The ZigBee standard allows for “pairing” or “binding” of devices so that, for example, a wall mounted light switch incorporating a ZigBee radio module may be bound with an appropriate lamp incorporating a ZigBee radio module. A user operating the light switch causes the radio module of said switch to transmit a radio message which is received by the master or coordinator radio device which is coordinating a piconet comprising the light switch, several lamps and perhaps other devices. The co-ordinator then consults a stored binding table for a device address associated with the address of the light switch. The coordinator then forwards the message to said bound device (in this example a lamp bound to the switch) which, upon receiving the message, lights up for example.

Applicants co-pending application WO01/28156 published on the 19^{th} of April in 2001 describes, in a lighting context, logical linking, binding or pairing in more detail. In particular, the binding or pairing table is created by, in one example, the manual pressing of pushbuttons on switches and lamps whilst in a set-up mode. However, in a lighting application in an office or warehouse, there may be many tens or hundreds of lamps in a radio controlled lighting network, some or most of which may be ceiling mounted and hence less accessible to an installation engineer. Another way of configuring such a network may involve an engineer temporarily associating a laptop or other computer with the network, discovering devices and manually configuring the binding table for the network. Such installation may be time consuming, require much planning, and may prove expensive to an end user due to the need for specialist configuration.

Additionally, once configured, there may be a problem with a network deployed over a reasonable area and perhaps comprising many piconets since a lamp may be out of radio range of the radio lamp switch instigating a control message. In such cases the network layer of the radio devices may employ a routing methodology to route the control message across piconets to the destination device. The routing will typically involve many hops in a large network, thereby instilling delay in the delivery of the message.

Minimising such delay, or latency, in a lighting application is particularly important since a user or consumer expects, at “a flick of a switch”, a lamp or many lamps to operate almost instantaneously. Strict latency requirements for lighting applications are therefore typically stipulated, creating a problem for multi-hop routing methodologies in large or dense networks. The problem is further compounded when a one-to-many message is required (as will occur when the switch has been paired with many lamps) since the control message must be reissued for each device until all paired devices have acknowledged receipt.

There is therefore a desire to provide a method of configuring a network to enable the selective operation of a group of devices whilst decreasing latency.

In an aspect of the present invention, data from the binding table set-up at installation is used to generate a group identifier. The coordinator then issues (unicasts) the group identifier in turn to each identified bound device.

Messages comprising a group identifier and command or control data in the payload of the message are subsequently broadcast or “flooded” to all devices to decrease latency (since broadcast messages require no two way acknowledgement of receipt). However, whilst all coordinator devices respond in typical fashion to the broadcast by rebroadcasting it, those having previously received the group identifier also respond to the control data in the broadcast message.

Hence, binding information provided at configuration is advantageously used to enable broadcasting of messages with a selective response of the network.

In a ZigBee lighting embodiment, the lighting radio network comprises battery powered slave or reduced function light switches, and mains powered master or co-ordinator luminaires (lamps). A coordinator luminaire, upon receiving a message from a light switch in radio range (1-20 metres or so), broadcasts the message (i.e. sets the MAC layer destination identifier to 0xFFFF) and includes a group identifier for that light switch in the message (i.e. in a Network layer header field an appropriate group identifier is inserted). Another co-ordinator luminaire receives the message, notes it is a broadcast, notes the presence and value of any group identifier and then re-broadcasts the message. Application layer code in that coordinator device/luminaire also checks the received group identifier with a previously stored group identifier, and operates the luminaire by responding to command data in the message only if a match is found.

In a further embodiment, since a broadcast message is not acknowledged in the ZigBee scheme, the originating coordinator unicasts the message to each bound luminaire following the broadcast. This ensures operation of all intended logically linked and bound recipients of the group in the event that the broadcast was not received by say one of the recipients due to radio frequency interference, or shadowing.

In yet a further embodiment, the broadcast also contains a time-to-live counter, which is decremented by each receiving luminaire. A luminaires receiving the broadcast with a count of 1, does not re-broadcast the message. This embodiment enables a broadcast to be restricted to a particular coverage area (a large room in an office building for example) whilst still allowing fast deployment of a message and group targeting.

### BRIEF DESCRIPTION OF DRAWINGS

The present invention will now be described, by way of example only, and with reference to the accompanying drawings wherein:

FIG. 1 is a diagram of a radio network deployed in a lighting application,

FIG. 2 is a block diagram of a radio device (L1) applied to a luminaire,

FIG. 3 is an example binding table stored by device L1,

FIG. 4 is an example radio message issued by L1,

FIG. 5 is a flow chart embodying a configuration process, and

FIG. 6 is a flow chart describing a network broadcast process following configuration.

It should be noted that the Figures are diagrammatic and not drawn to scale. Relative dimensions and proportions of parts of these Figures have been shown exaggerated or reduced in size, for the sake of clarity and convenience in the drawings. The same reference signs are generally used to refer to corresponding or similar features in modified and different embodiments.

### DETAILED DESCRIPTION

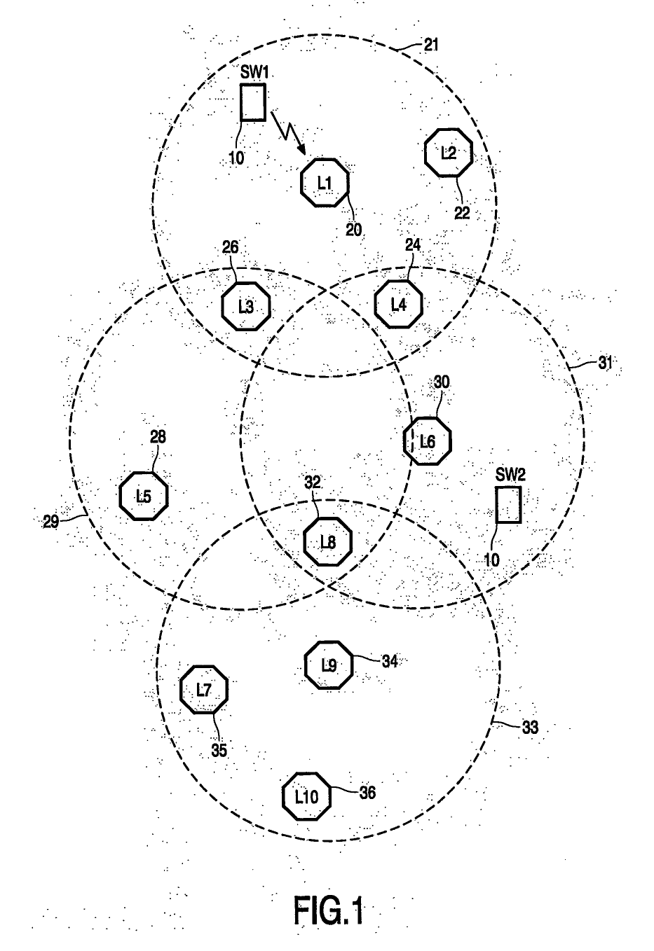

FIG. 1 illustrates part of a ZigBee radio network employed in a building for lighting or luminaire application and control. The network employs battery powered radio lamp switches 10 (SW1), (SW2) and mains powered radio luminaires L1 to L10. The luminaires each comprise a coordinating (or full function) radio device which has a radio range over which messages may be transmitted and received. In this example employing the ZigBee radio standard, the range would typically cover an area having a radius of 10 to 30 metres or so. The radio range for luminaire 20 (L1) is shown in the Figure by dashed line 21, that of L5 by dashed line 29, that of L6 by dashed line 31 and that of L8 by dashed line 33. Note that for the sake of clarity, the range for only some of the devices L1-L10 is shown in the Figure. The schematic diagram of FIG. 1 may therefore represent lamps deployed in a large warehouse, some of which (L1, L3 for example) are within radio range of each other.

In this example lamp device L1 co-ordinates messages from switch device SW1, whilst switch device SW2 is coordinated by device L6. In effect, L1 and SW1 form a master/slave piconet, as does L6 and SW2. The other co-ordinating devices each form their own respective piconets, with the ZigBee standard enabling coordinator to coordinator (i.e. cross-piconet) message exchanges. Hence a radio message issued by SW1 will be received and acted upon by L1, which may forward the message to another coordinating node device in range (L3 for example).

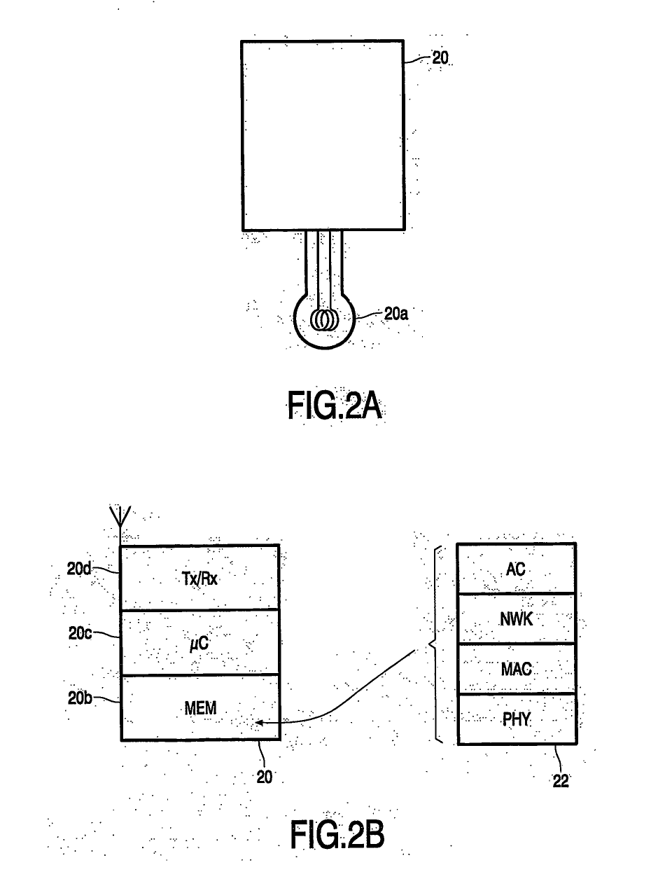

FIG. 2a illustrates in more detail an example network coordinating node L1 in the form of a ZigBee radio module 20 connected to a light bulb 20a. FIG. 2b shows the radio module 20 part of said luminaire device. The module comprises an antenna and transceiver 20d (Tx/Rx) connected to a microcontroller 20c (μC) which in turn is connected to a memory store in the form of flash RAM 20b (MEM). The memory stores program code comprising a ZigBee radio software stack 22. The stack a bottom physical layer (PHYS), followed by a medium access control layer (MAC), followed by a network layer (NWK) and a top application layer (APP).

The PHYS and MAC layers are provided with a ZigBee compliant radio module L1-L10, SW1, SW2 whilst the NWK and APP layers may be defined by the developer and installed prior to application at a customer site. In this example, lighting application code and profiles (as defined by the ZigBee Alliance) are provided. Also provided, as will be described shortly, is program code which enables group identification and low latency message transfer to be enacted.

Returning to FIG. 1, suppose at installation the user required that radio light switch device 10 (SW1) be configured to operate luminaire devices 22 (L2), 24 (L4), 32 (L8), 34 (L9) and luminaire 36 (L10). An installing engineer must therefore “bind” devices having radio identifiers L2, L4, L8, L9 and L10 to the device having identifier SW1. (Note that actual device identifiers or radio addresses are defined as unique 64-bit IEEE addresses in the ZigBee standard, but for the sake of simplicity and example are referred to here as L2, L4 and so on).

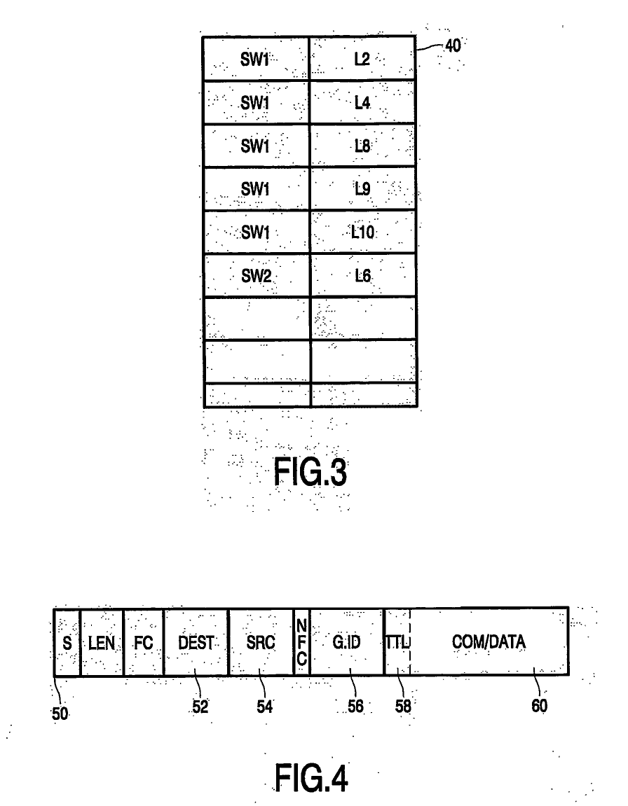

This is achieved by installing a binding table in the memory 20b of the device (L1) which co-ordinates the switch SW1. An example binding table stored in device L1 appropriate for this example is shown in FIG. 3. The table 40 comprises a first column having the switch identifier (SW1) and a second column having a lamp device address to which the switch is bound.

The provision of the table hence enables L1 to receive a message from switch SW1, look-up “bound” device addresses and forward the message to other devices (which may or may not be members of the L1 piconet) in range. Referring to FIG. 1, L1 forwards a radio message to L2 by including a destination address (L2) in said radio message as is well known to those skilled in the art. L3 and L4 will “hear” the message and either ignore it or attempt to route it to L2. The device L1, upon receiving an acknowledgement message from L2, will then target a message for the next bound device in the table 40, L4 and so on. Considering the network arrangement of FIG. 1, some 3 hops are required for the message to reach L8, and four hops for L9 and five hops for L10. Hence, an unacceptable delay may occur when compared with strict latency requirements of for example 250 ms from instigation (SW1 transmitting a message) to response (all bound lamps illuminate).

As will be recognised by those skilled in the art, in a lighting or other sensor scenario there may be many tens or even hundreds of lamps/sensors and switches scattered in various piconet arrangements. As those skilled in the art will recognise, latency delays in messages reaching their bound targets typically scale in a power law relation with network size (or hop count). Hence, simple repeated network routing of a message to each target may result in unacceptable delays from an application requirement in large networks.

One method by which such a delay may be shortened comprises broadcasting or flooding the original message throughout the network, rather than unicasting the message to each intended recipient. This comprises signifying in a radio message that the message is a broadcast. This is achieved in ZigBee by setting the destination address in the MAC header field of a message to the value 0xFFFF. Such broadcasts do not typically require acknowledgement in the ZigBee standard, which helps to reduce latency. Hence, L1 would broadcast the message from SW1 to those in range, that is L2, L3, L4. Having acted upon the data, those devices then re-broadcast the message. Hence the message “floods” through the network. However, whilst the ZigBee radio standard has a process for broadcasting, simply applying that broadcasting process to the network of FIG. 1 would turn all lamp devices on (or off, if already on).

Hence, it is not at present possible to indicate in a broadcast message which devices should respond. Applicants have realised an efficient way to achieve this. Recall that during set-up a binding table 40 (FIG. 3) was supplied to device L1 during engineer installation and configuration.

It is proposed that in a further configuration step, an identifier signifying the group (L2,L4, L8, L9, L10) of devices bound to switch 1 (SW1) is generated by the microcontroller and program code of, in this example, device L1. For example, the identifier may simply be a first selected group number, i.e. “0”, or may be the actual identifier of the switching device “SW1”. This group identifier is then transmitted in turn (i.e. unicast) by device L1 to each bound device, which upon receiving the group identifier stores the identifier in memory 20b and acknowledges receipt of the message.

FIG. 4 illustrates the structure of a ZigBee radio message for use with the group identifier. The message 50 comprises MAC layer header fields S—start of message, LEN—length of message, FC—frame count and identifier fields 52 DEST—destination (or target) address for message, field 54 SRC—source address (sender) of message. There then follows fields 56 in which a group identifier may be inserted, optional field 58 in which a time-to-live counter may be inserted, and the data field 60 for command or data bytes of the message.

FIG. 5 illustrates process steps taken by device L1 to generate and provide a group identifier to selected recipients. The process is initiated by application layer code after an engineer has provided a binding table to a device. At step 70 (CBT) the microcontroller 20c of device L1 checks for entries in its stored 20b binding table 40 and having found entries then goes onto step 80 where the microcontroller generates a group identifier (G. G.ID). In this example the identifier is simply the address entry ‘SW1’ in the binding table. Having generated a group identifier, the microcontroller initiates step 90 where a message for each device associated with the group identifier is generated and transmitted. Hence a message having in field 52 the destination address ‘L2’ and in field 56 the group identifier ‘SW1’ is generated and transmitted by device L1. Upon receiving the message, network layer code in the recipient ‘L2’ retrieves the group identifier data ‘SW1’ from field 56 and stores this in memory 20b for future use and acknowledges the message. This is repeated by device L1 for each device in its binding table 40 for which there is an entry. Hence, at step 90, a group identifier is unicast to each group member who stores the group identifier.

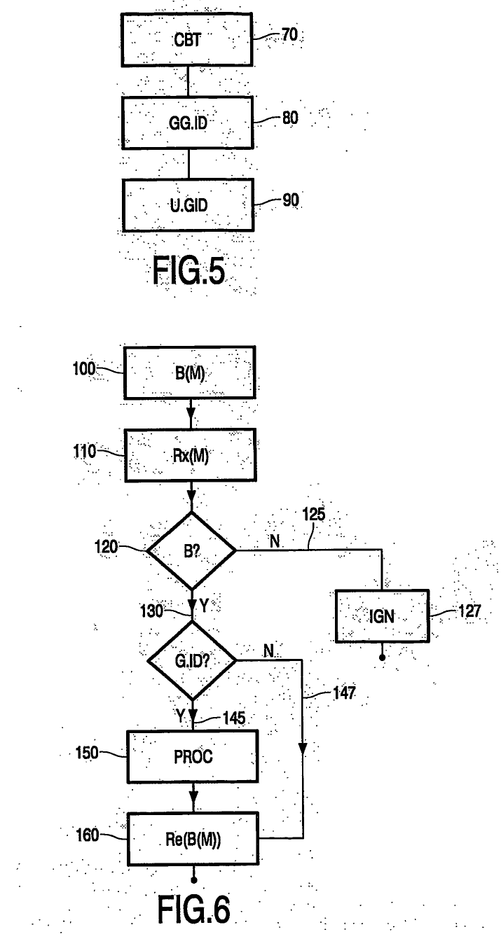

Having provided the group identifier, the network may then operate the process as described in FIG. 6 wherein at step 100 device L1 receives a message from switch SW1 indicating that the user has flicked said switch. Device L1 checks its binding table and finding more than one entry bound to switch SW1 initiates a broadcast message (B(M)). The coordinator L1 indicate the message as a broadcast message by inserting 0xFFFF in the destination field 52 of the message. It also inserts the group identifier ‘SW1’ which is associated with the originator of the message into field 56 of said broadcast message. The message is then transmitted over the air by the transceiver 20d of device L1.

A device in range subsequently receives the broadcast message at step 110 (Rx(M)) and program code in the stack 22 of that receiving device checks whether the message is a broadcast message (B?) at step 120. If it is (signified by the presence of 0xFFFF in the appropriate field 52) then the device follows path 130 to step 140 whereby the message is examined for a group identifier in the message field 56. If the message has a group identifier (for example in this case ‘SW1’) then the device compares that group identifier with its previously stored group identifiers (if any) and if a match is found process flow continues to processing step 150 (PROC). At this step, the device passes the message command data (field 60) to program code of the application layer which causes, for example the lamp to light, and finally the device rebroadcasts the message Re(B(M) at step 160.

If at step 120 the message is not a broadcast message, and the destination address in the message is not that of the receiving device, then the message is a unicast message for another device, and the receiving device follows path 125 to block 127 wherein the message is ignored.

If at step 140 the message is a broadcast but does not contain a group identifier then flow continues via path 147 wherein the message data is rebroadcast.

Hence, the broadcast mechanism within the ZigBee radio standard may be used, together with binding table data to enable a selective response to a broadcast message. This has particular application to low latency applications such as lighting, where a network may be installed over a wide area and wherein a user expects an almost instantaneous response to a message.

In a further embodiment, the originator of the broadcast may unicast further messages to each bound device after broadcasting. Hence, any bound device which did not receive or respond to the broadcast will receive a normal message targeted for it. Whilst this helps to ensure the operation of all intended recipient devices, those devices receiving a unicast will of course operate later in time than those which successfully responded to the broadcast. However, in a randomly noisy radio environment it may be that occasionally a broadcast is not received by at least one of the devices, and this extra step assures a user that the system is working, albeit perhaps not perfectly for that particular instance of a switching event.

In yet a further embodiment, time-to-live counter data may be inserted in the broadcast message by the instigator of the broadcast. Devices receiving the broadcast then check for the counter, decrement it by one, compare it with a predetermined threshold (for example COUNT>1?) and broadcast the message depending on said comparison. Hence the number of hops for a message may be intentionally limited, thereby effectively restricting the range of a broadcast group message. This helps to keep the air clear of unnecessary radio traffic, and in particular helps in part a broadcast from being rebroadcast repeatedly by a device which does not realise that it has already rebroadcast said message.

In the above a system employing ZigBee radio devices is described, the system operating according to a ZigBee radio standard and the aforementioned methods. The system and method advantageously allows a configuration step wherein binding data is reused to enable selective broadcasting to bound devices. Whilst the above embodiments describe a lighting system, those skilled in the art will recognise that other application scenarios requiring low latency multi-device responses may enjoy aspects of the present invention.

Furthermore, aspects of the present invention, whilst described in context of the ZigBee radio standard, may equally enjoy application in other radio standards and application scenarios where network latency in a large network is an issue. Additionally, the broadcasting was described as being instigated from a co-ordinator device. Those skilled in the art will realise that the device instigating the original request (the light switch SW1) may itself issue the broadcast provided it has been supplied with the generated group identifier associated with it and program code for inserting said group identifier into a broadcast message.

From reading the present disclosure, other modifications will be apparent to persons skilled in the art. Such modifications may involve other features which are already known in the design, manufacture, deployment and configuration of low power digital radio systems, infrastructure and component parts thereof and which may be used instead of or in addition to features already described herein without departing from the spirit and scope of the present invention.

1. A method for configuring a group of radio devices in a radio network to selectively respond to a broadcast radio message broadcast by a coordinator device (20), wherein said coordinator device stores a binding table (40) describing identified devices (22, 24) which are logically linked to a further device (10), the method comprising generating a group identifier (SW1) for those identified devices, which according to said binding table are logically linked to a further device, transmitting to each identified device said generated group identifier, and wherein said generated group identifier is stored by each receiving identified device.

2. A method according to claim 1, wherein following the configuration, the operation of said further device causes a radio message (50) comprising command data (60) to be transmitted from said further device (10) to its coordinator device (20), and wherein upon receiving said message, said coordinator device generates a broadcast message (50) which includes the group identifier and said command data and broadcasts said message.

3. A method according to claim 2, wherein devices receiving said broadcast message check the group identifier of said message with previously stored group identifiers to at least in part determine whether to respond to command data in the broadcast message.

4. A method according to claim 3, wherein following said broadcast, the coordinator device (20) unicasts messages to each member of the group in turn which acknowledge receipt of said message.

5. A method according to claim 4, wherein the received broadcast message (50) is rebroadcast by the receiving device following said determination.

6. A method according to claim 5, wherein a counter (58) provided in the received broadcast (50) is decremented by the receiving device and wherein the rebroadcasting of said message is based on a comparison of the decremented value of the counter with a predetermined threshold.

7. A method according to any preceding claim, wherein said further device (10) itself broadcasts a message including a group identifier to other devices within range.

8. A radio system comprising a plurality of radio devices (10, 20, 30), some of which are coordinator devices (20) which co-ordinate other devices to form piconets (21, 31), and wherein a radio network comprising said piconets is formed and wherein network communication comprising radio messages (50) is arranged according to a predetermined radio standard (22), and wherein at least one coordinating device (20) has means (20b) for storing a binding table (40) describing logical links between devices of the network, means (20c) for generating a group identifier (56) associated with said logical links and means (20d) for, in a configuration step, supplying said group identifier to said linked devices which respectively store (20b) said supplied group identifier.

9. A radio system according to claim 8, where in operation, radio messages (50) comprising command data from a logically linked device (10) are received by said co-ordinator device (20) which inserts (56) said group identifier into said message and broadcasts said message to the network.

10. A radio system according to claim 9, wherein radio devices receiving said broadcast messages compare the group identifier of the message with their previously stored group identifier and respond to command data in said broadcast messages in dependence on said group identifier comparison.

11. A coordinator radio device (20) for use with the system of any one of claims 8 to 10, said device comprising means (20b) for storing a binding table describing logical links between devices of the network, means (20c) for generating a group identifier associated with said logical links, means (20d) for supplying said group identifier to said linked devices, and means (20c) for inserting said group identifier in subsequent broadcast radio messages.

12. A radio device (24) for use with the system of any one of claims 8 to 10, comprising means (20b) for storing a received group identifier and means (20c) for determining whether to respond to a message by comparing said stored group identifier with that included in subsequent broadcast messages.
